(19) United States
(12) Patent Application Publication
(10) Pub. No.: US 2007/0077136 A1
(43) Pub. Date: Apr. 5, 2007

(54) Device for handling disk-like objects

(75) Inventor: Rene Schenck, Jena (DE)

Correspondence Address: SIMPSON & SIMPSON, PLLC, 5555 MAIN STREET, WILLIAMSVILLE, NY, 14221-5406, US

(73) Assignee: Vistec Semiconductor Systems GmbH, Wetzlar (DE)

(21) Appl. No.: 11/400,920

(22) Filed: Apr. 10, 2006

(30) Foreign Application Priority Data
Apr. 14, 2005 (DE) 10 2005 017 164.8

(51) Int. Cl. B65H 3/08; B65G 59/02

(52) U.S. Cl. 414/797

(57) ABSTRACT

An apparatus for handling disk-like objects is disclosed, wherein the apparatus consists of at least one load port, one transfer unit, and one system unit. Between the transfer unit and the system unit an internal separating wall is formed. Further, an external separating wall is provided, which is constructed in such a way that it positions the transfer unit in a first partial room and the system unit in a second partial room.

### CROSS REFERENCE TO RELATED APPLICATIONS

This patent application claims priority of German Patent Application No. 10 2005 017 164.8, filed on Apr. 14, 2005, which application is incorporated herein by reference.

### FIELD OF THE INVENTION

The present invention relates to a device for handling disk-like objects. In particular, the present invention relates to a device for handling disk-like objects, comprising at least one load port, wherein the load port is connected to a transfer unit for the disk-like objects, and wherein the transfer unit is connected to a system unit for inspecting or processing the disk-like objects.

### BACKGROUND OF THE INVENTION

The unpublished German Patent Application DE 103 51 874.7 discloses a system for detecting macro defects. This system is surrounded by a housing and subdivided into a first section, a second section, and a third section. In the second section, a stage is provided which can be traversed in the x and y directions, on which a wafer is placed. In the first section there is a suction means, which passes the sucked-in air to the second section via an air passage, the air passage comprising a plurality of air deflection sheets so that an air flow is guided in parallel across the wafer. However, nothing is disclosed with respect to the deployment conditions in a clean room or a factory for the manufacture and production of disk-like objects. German Patent DE 43 10 149 C2 discloses an apparatus for handling disk-like objects at the handling level of a local clean room. Further, magazine receptors are provided which can be adjusted in height with respect to the handling level. Within the handling level, there are process stations for processing and inspection purposes. The handling level is arranged above an intermediate floor subdividing the clean room into two partial rooms on top of each other, in which one air flow component of an air flow from the partial room above the dividing wall is directed into the partial room below the dividing wall containing drive units. The air flow serves to prevent abrasion caused by the drive elements from passing to the process stations in the handling level.

European Patent EP 0 335 752 discloses a system for semiconductor manufacture in clean room conditions. This-system consists of a building surrounded by walls wherein clean room conditions are prevalent in part of the building. Air is passed to the clean room via filters. Holes in the floor of the clean room pass the clean air to the other part of the installation. Nothing is disclosed on how the air flow is passed or guided. There is no disclosure with respect to the pressure differentials within the clean room, either.

U.S. Pat. No. 6,326,298 discloses a system for automatic wafer inspection with respect to defects. This system discloses a wafer feeding unit and a system unit in which the inspection is carried out. The feeding unit has an opening through which the wafer or the disk-like object is transferred to the system unit. There is nothing to suggest a separation or pressure differentials between the system unit and the feeding unit or with respect to the remaining room in which the system has been installed.

### SUMMARY OF THE INVENTION

It is therefore an object of the present invention to create an apparatus exposed to various clean room conditions and which ensures that contamination of the disk-like objects is reduced.

The present object is achieved by an apparatus for handling disk-like objects, comprising at least one load port, wherein the load port is connected to a transfer unit for the disk-like objects, a system unit connected to the transfer unit is for inspecting or processing the disk-like objects, an internal separating wall is provided between the transfer unit and the system unit, and an external separating wall is provided in such a way that the transfer unit is positioned in a first partial room and the system unit is positioned in a second partial room.

It is particularly advantageous for an internal separating wall to be provided between the transfer unit and the system unit. This is aided by an external separating wall which is provided in such a way that the transfer unit is positioned in a first partial room and the system unit in a second partial room. Herein there is a pressure differential between the first partial room and the second partial room. The differential pressure between the first partial room and the second partial room can be as much as 10 Pa.

In the transfer unit there is a heightened pressure with respect to the first partial room. The pressure difference is at least 1.25 Pa. The transfer unit has a top surface, a bottom surface, and at least one side facing a load port. The top surface, the bottom surface, and the side facing the load port are in contact with the first partial room, wherein in the first partial room there is a heightened pressure with respect to the second partial room. The contact interface towards the second partial room, in which there is a heightened pressure with respect to the first partial room, is sealed by means of corresponding sealing profiles on the cladding.

The internal separating wall between the transfer unit and the system unit has an opening with dimensions making it suitable for the transfer of the disk-like objects from and to the system unit. The internal separating wall serves to uncouple the system unit from the transfer unit pneumatically.

Further advantageous embodiments of the invention can be seen from the dependent claims.

### BRIEF DESCRIPTION OF THE DRAWINGS

The subject of the invention is schematically shown in the drawings and will be described in the following with respect to the accompanying drawings, in which:

FIG. 1 is a schematic view of an apparatus for inspecting disk-like objects;

FIG. 2 is a schematic top view of the apparatus illustrating the arrangement of the external separating wall;

FIG. 3 is a side view of the apparatus shown in FIG. 2, wherein here the arrangement of the internal separating wall between the system unit and the transfer unit is illustrated; and,

FIG. 4 is a side view of the apparatus, wherein a simplified embodiment of the separating wall is shown.

### DETAILED DESCRIPTION OF THE INVENTION

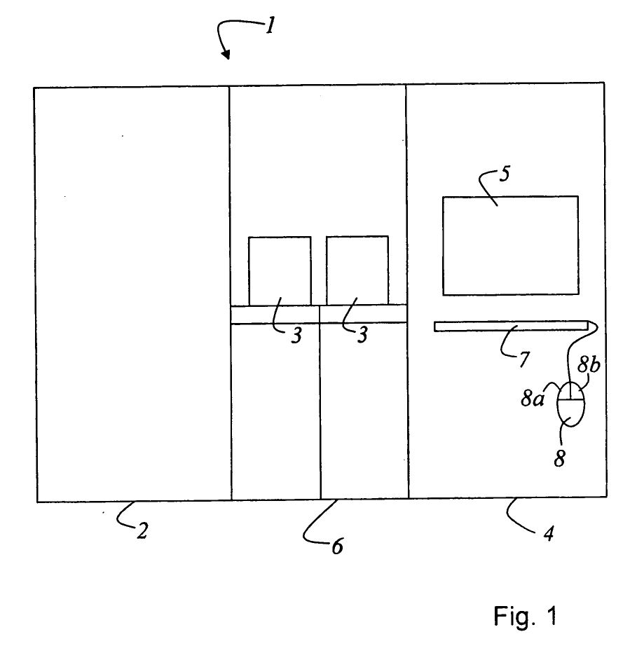

With reference to FIG. 1, an apparatus for inspecting disk-like objects is shown. Apparatus 1 can consist of a plurality of modules which can be combined according to the users' specifications and the users' inspection requirements. For example, the apparatus can comprise a module 2 for macro-inspection of disk-like objects. In addition, apparatus 1 can also have a module 4 for micro-inspection of disk-like objects. The disk-like objects are transferred to apparatus 1 with the aid of at least one container 3. Apparatus 1 comprises a display 5 on which various user interfaces can be shown. A keyboard 7 is also associated with apparatus 1 enabling the user to effect inputs to the apparatus to therefore change the control of apparatus 1 in a desired way. A further input unit 8 can also be associated with the keyboard enabling the user to control a cursor on display 5. The input unit 8 comprises a first input element 8a and a second input element 8b. In a preferred embodiment, input unit 8 is configured as a computer mouse. The disk-like objects are transferred to the apparatus with the aid of containers 3. Apparatus 1 comprises at least one load port 9, through which the disk-like objects are received in apparatus 1. Apparatus 1 consists of at least one transfer unit 6 and at least one apparatus unit 10. In the embodiment shown in FIG. 1, two system units are provided as a module. Herein, one system unit is a module 2 for macro-inspection, and another system unit is a module 4 for micro-inspection of disk-like objects.

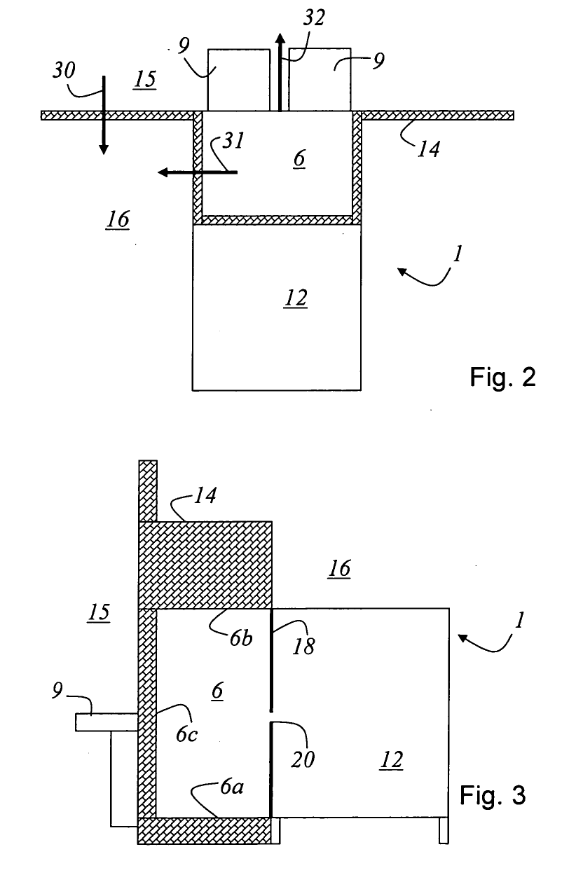

FIG. 2 shows a top view of the apparatus 1 for handling disk-like objects. The apparatus 1 has at least one load port 9 in communication with a transfer unit 6. When operating apparatus 1, the disk-like objects, which are brought to the load ports 9 within containers 3, are handed over to the transfer unit 6 through the load ports 9. Transfer unit 6 in turn is connected to a system unit 12. Transfer unit 6 serves to transport the disk-like objects to and from the system unit 12. In system unit 12 the disk-like objects are inspected or processed. System 1 is installed in a clean room or a factory for the production of disk-like objects in such a way that certain parts of system 1 are exposed to different clean room conditions or laboratory conditions than other parts of system 1. This is achieved by providing an external separating wall 14, which subdivides the installation room of system 1 into a first partial room 15 and a second partial room 16. By means of separating wall 14 therefore pressure differentials are achieved between the first partial room 15 and the second partial room 16. In the first partial room 15 there is a heightened pressure with respect to the second partial room 16. The differential pressure between the first partial room 15 and the second partial room 16 can be up to about 10 Pa. There is also a heightened pressure from within the transport unit 6 with respect to the second partial room. Moreover, there is a heightened pressure from within the transfer unit 6 with respect to the first partial room. The pressure differential between the interior of the transfer unit 6 and the first partial room 15 is at least 1.25 Pa.

FIG. 3 is a side view of the system of FIG. 2. Transfer unit 6 and system unit 12 are separated from each other by an internal separating wall 18. The internal separating wall 18 has an opening 20 which is configured with respect to the size of the opening to be sufficient for the transport from and to the system unit 12. Transfer unit 6 has a top surface 6a, a bottom surface 6b, and a side 6c facing load port 9. The contact interfaces towards the second partial room 16 are sealed by separating wall 14 and by means of corresponding sealing profiles. The internal separating wall 15 between the transfer unit 6 and the system unit 12 can also be configured as a separating metal sheet. The system unit 12 is pneumatically uncoupled from the transfer unit 6 due to the opening which is only configured for transporting the disk-like objects from and to system unit 12. The bottom surface 6b, the top surface 6a, and the side 6c facing load port 9 of the transfer unit 6 are each surrounded by wall elements of separating wall 14.

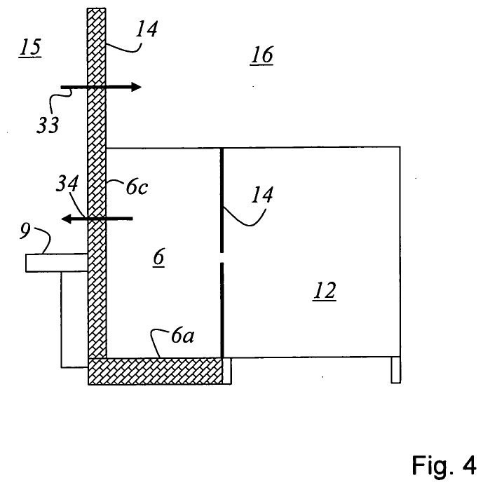

FIG. 4 shows another embodiment of the external separating wall 14. In this embodiment only the bottom surface 6b and the side 6c facing the load port of the transfer unit 6 are surrounded by the external separating wall 14. This is a simplified form of the external separating wall 14, which achieves the same result as the embodiment of FIG. 3.

The arrows shown in FIGS. 2 and 4 reflect the pressure differentials between the first partial room 15 and the second partial room 16. Arrow 30 in FIG. 2 is a schematic representation of the pressure differential between the first partial room 15 and the second partial room 16. There is thus a heightened pressure in the first partial room 15 with respect to the second partial room 16. The pressure differential between the first partial room 15 and the second partial room 16 can be as much as 10 Pa. Arrow 31 in FIG. 2 represents the heightened pressure within transfer unit 6 with respect to the second partial room 16. Arrow 32 represents the heightened pressure within transfer unit 6 with respect to the first partial room 15. The heightened pressure within transfer unit 6 with respect to the first partial room 15 should be at least 1.25 Pa. In FIG. 4 arrow 33 represents the heightened pressure within the first partial room 15 with respect to the second partial room 16. Arrow 34 also represents the heightened pressure within the transfer unit 6 with respect to the first partial room 15. The necessary pressure differentials essentially correspond to those already mentioned in the description with reference to FIG. 2.

What is claimed is:

1. An apparatus for handling disk-like objects, comprising at least one load port, wherein the load port is connected to a transfer unit for the disk-like objects, a system unit connected to the transfer unit is for inspecting or processing the disk-like objects, an internal separating wall is provided between the transfer unit and the system unit, and an external separating wall is provided in such a way that the transfer unit is positioned in a first partial room and the system unit is positioned in a second partial room.

2. The apparatus according to claim 1, wherein there is a pressure differential between the first partial room and the second partial room.

3. The apparatus according to claim 2, wherein the pressure differential between the first partial room and the second partial room is as much as 10 Pa.

4. The apparatus according to claim 1, wherein the transfer unit has a heightened pressure with respect to the first partial room.

5. The apparatus according to claim 4, wherein the heightened pressure is higher by at least 1.25 Pa.

6. The apparatus according to claim 1, wherein the transfer unit has a top surface, a bottom surface, and a side facing the at least one load port, and in that the top surface, the bottom surface, and the side facing the load port are in contact with the first partial room, in which there is a heightened pressure with respect to the second partial room, and in that the contact interface towards the second partial room, in which there is a heightened pressure with respect to the first partial room, is sealed by means of corresponding sealing profiles on the cladding.

7. The apparatus according to claim 6, wherein the separating wall is formed in such a way that the top surface of the transfer unit is not in contact with the first partial room, in which there is a heightened pressure with respect to the second partial room.

8. The apparatus according to claim 1, wherein the internal separating wall between the transfer unit and the system unit has only one opening, which is configured for transferring the disk-like objects from and to the system unit, and in that this serves to uncouple the system unit pneumatically from the transfer unit.

9. The apparatus according to claim 1, wherein the disk-like object is a wafer.

10. The apparatus according to claim 1, wherein the disk-like object is a wafer on a glass substrate.

11. The apparatus according to claim 1, wherein the disk-like object is a mask for lithographic processes.
